(19) United States
(12) Patent Application Publication
(10) Pub. No.: US 2009/0066216 A1
(43) Pub. Date: Mar. 12, 2009

(54) FIELD EMISSION LIGHT SOURCE

(75) Inventors: Wei-Qi Fu, Beijing (CN); Yang Wei, Beijing (CN); Peng Liu, Beijing (CN); Liang Liu, Beijing (CN); Shou-Shan Fan, Beijing (CN)

Correspondence Address: PCE INDUSTRY, INC.;ATT. CHENG-JU CHIANG, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Tu-Cheng (TW)

(21) Appl. No.: 11/945,538

(22) Filed: Nov. 27, 2007

(30) Foreign Application Priority Data
Sep. 7, 2007 (CN) 200710077011.X

(51) Int. Cl. H01J 1/62

(52) U.S. Cl. 313/495

(57) ABSTRACT

A field emission light source includes a foundation, a supporting member, a transparent shell, an anode, and a cathode. The transparent shell is disposed on the foundation, and thus defines a closed space in the transparent shell. The supporting member includes a first end and a second end opposite to the first end. The first end is connected to the foundation, and the second end is disposed at a center portion of the closed space. The cathode includes a plurality of carbon nanotubes. The cathode is disposed on the second end of the supporting member.

### BACKGROUND OF THE INVENTION

1. Field of the Invention

The invention relates generally to light sources and, particularly, to a field emission light source.

2. Discussion of Related Art

A field emission light source is a newly emerging light source technology. Luminescence principle of the field emission source was reported in an article by Mirko Croci et al, entitled “A Fully Sealed Luminescent Tube Based on Carbon Nanotube Field Emission” (Microelectronics Journal, Vol. 35, 2004, p 329-336). The luminescence principle of the field emission source is described in detail as follows. Small or low electric potential are capable of influencing electron emitters (e.g. metal tips, carbon nanotubes, etc.) to emit electrons. The electrons can be guided by another electric field, of high potential, to bombard a fluorescent layer to produce visible light.

Currently, research on carbon nanotube based field emission light sources are mainly concentrated on the field of planar light sources, which mostly are used as light sources in all kinds of backlight modules. In planar light sources, due to a shielding effect therein, the number of carbon nanotubes effectively emitting electrons is small. Therefore, luminescence efficiency of planar light sources is relatively low.

What is needed, therefore, is a field emission light source having high luminescence efficiency.

### SUMMARY OF THE INVENTION

In one embodiment, a field emission light source includes a foundation, a supporting member, a transparent shell, an anode, and a cathode. The transparent shell is disposed on the foundation, and thus defines a closed space in the transparent shell. The supporting member includes a first end and a second end opposite to the first end. The first end of the supporting member is connected to the foundation, and the second end is disposed at a center portion of the closed space. The cathode includes a polyhedron-shaped, spherical-shaped, or elliptical-shaped base and a number of carbon nanotubes arranged on the base. The cathode is connected to the second end of the supporting member. The anode is disposed on an inner surface of the transparent shell, and a fluorescent layer is further disposed on the anode.

Other advantages and novel features of the present field emission light source will become more apparent from the following detailed description of presents embodiments when taken in conjunction with the accompanying drawings.

### BRIEF DESCRIPTION OF THE DRAWINGS

Many aspects of the present field emission light source can be better understood with reference to the following drawings. The components in the drawings are not necessarily to scale, the emphasis instead being placed upon clearly illustrating the principles of the present field emission light source.

FIG. 1 is a schematic view of a field emission light source, in accordance with a present embodiment.

FIG. 2 is a current-voltage curve of the field emission light source shown in FIG. 1.

FIG. 3 shows a field emission stability test curve of the field emission light source shown in FIG. 1.

Corresponding reference characters indicate corresponding parts throughout the several views. The exemplifications set out herein illustrate at least one preferred embodiment of the present field emission light source, in at least one form, and such exemplifications are not to be construed as limiting the scope of the invention in any manner.

### DETAILED DESCRIPTION OF THE INVENTION

Reference will now be made to the drawings to describe, in detail, embodiments of the present field emission light source.

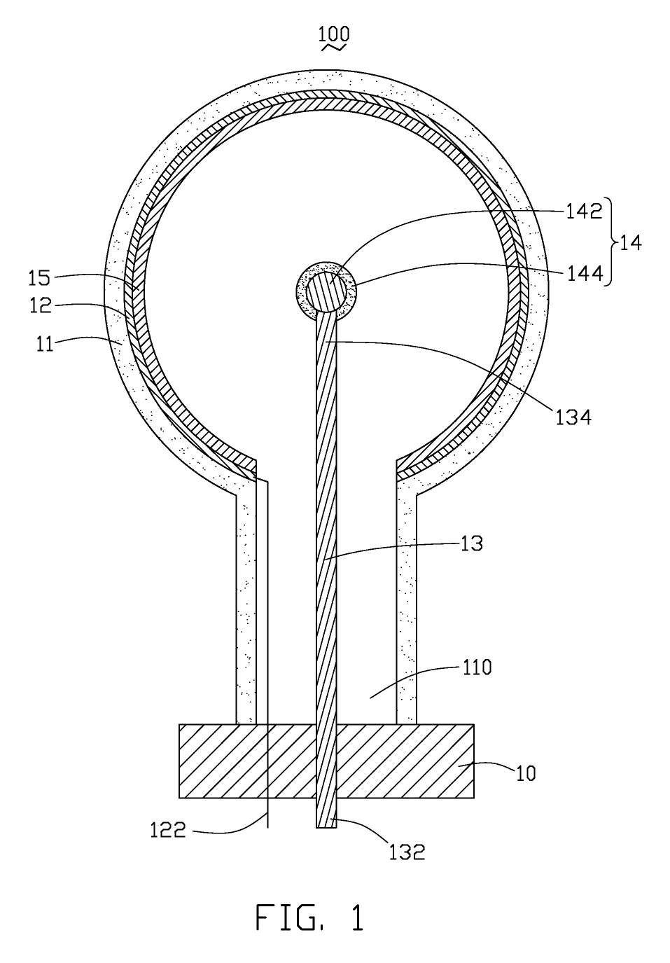

Referring to FIG. 1, a field emission light source 100 in accordance with a present embodiment is shown. The field emission light source 100 includes a foundation 10, a supporting member 13, a transparent shell 11, an anode 12, and a cathode 14. The transparent shell 11 is disposed on the foundation 10, and thus defines a closed space therein. The supporting member 13 includes a first end 132 and a second end 134 opposite to the first end 132. The first end 132 of the supporting member 13 is connected to the foundation 10, and the second end 134 is disposed at a center portion of the closed space. The cathode 14 includes a polyhedron-shaped, spherical-shaped, or elliptical-shaped base 142 and a number of carbon nanotubes 144 arranged on the base 142. The cathode 14 is connected to the second end 134 of the supporting member 13. The anode 12 is disposed on an inner surface of the transparent shell 11, and further, a fluorescent layer 15 is disposed on the anode 12.

The foundation 10 is made of insulative materials, such as glass, ceramics, etc. One end of the transparent shell 11 has an opening 110. The end with the opening 110 is arranged on the foundation 10, and thus defines a closed space in the transparent shell 11. The transparent shell 11 is made of transparent insulative materials, such as glass or transparent ceramics. The transparent shell 11 is spherical-shaped, ellipsoidal-shaped, or pear-shaped. Specifically, the pear-shaped transparent shell 11 is selected in the present embodiment.

The anode 12 is a transparent conductive film, such as a tin indium oxide film, or an aluminum (Al) film. When the tin indium oxide film is used as the anode 12, the anode 12 is configured on an inner surface of the transparent shell 11. A conducting wire 122 is connected to the anode 12 through the foundation 10. The conducting wire 122 is used to connect the anode 12 to an electrical power source. Furthermore, when the tin oxide film is used as the anode 12, a phosphor layer 15 is disposed on an inner side of the anode 12. When the Al film is used as the anode 12, the phosphor layer 15 is installed between the anode 12 and the transparent shell 11. As such, the electrons emitted from the cathode 14 pass through the Al film and strike the phosphor layer 15 to produce luminescence. It is noted that the phosphor in the phosphor layer 15 is white phosphor, or color phosphor.

Due to the first end 132 extending out of the foundation 10, the first end 132 can be used to electrically contact the external electrical power source. The second end 134 is disposed at a center portion of the closed space. The supporting member 13 is made of metals or alloys having high conductivity, such as copper or aluminum.

In the cathode 14, a number of the carbon nanotubes 144 act as a cathode emitter 144 formed on the surface of the base 142. The base 142 is connected to the second end 134 of the supporting member 13. The spherical-shaped base 142 is selected in the present embodiment. The spherical-shaped base 142 enables the cathode 14 to uniformly emit electrons in all directions. As such, the polyhedron-shaped base 142 enables the cathode 14 to have different electrons emitting properties, emitting electrons in different directions. The base 142 can be made by metals, alloys, or non-metallic materials, which do not melt at temperature of about 500° C. or more. For example, the metal used to make the base 142 can be at least one of stainless steel, iron, cobalt, nickel, copper, and aluminum. Specifically, the stainless steel ball is selected to form the base 142. Quite usefully, the base 142 with the transparent shell 11 is configured with a concentric center. The distances from the points on the surface of the base 142 to the transparent shell 11 are equal. Thus enabling electrons to be emitted uniformly and evenly.

In the cathode 14, specifically, the carbon nanotubes can be bonded to the base 142 by a silver colloid. The carbon nanotbues can be single-walled carbon nanotubes or multi-walled carbon nanotubes. A length of the carbon nanotubes is in the approximate range from 10 μm (micrometer) to 10 mm (millimeter).

The transparent shell 11 needs to maintain a certain degree of vacuum therein. Quite usefully, a getter layer such as a non-evaporable getter metal layer (not shown) is configured on the inner surface of the transparent shell 11. The getter layer can be made by an evaporating deposition method, coated on the inner surface of the transparent shell 11. Specifically, the getter layer can be configured on the end close to the opening 110 within the inner surface of the transparent shell 11, or formed on the surface of the supporting member 13.

Due to the spherical-shaped cathode 14 used in the present embodiment, the field emission shield effect on the surface of cathode is decreased, and thus the number of carbon nanotubes available to emit electrons is increased. Thereby, the obtained spherical-shaped field emission light source has a high emitting efficiency and stability.

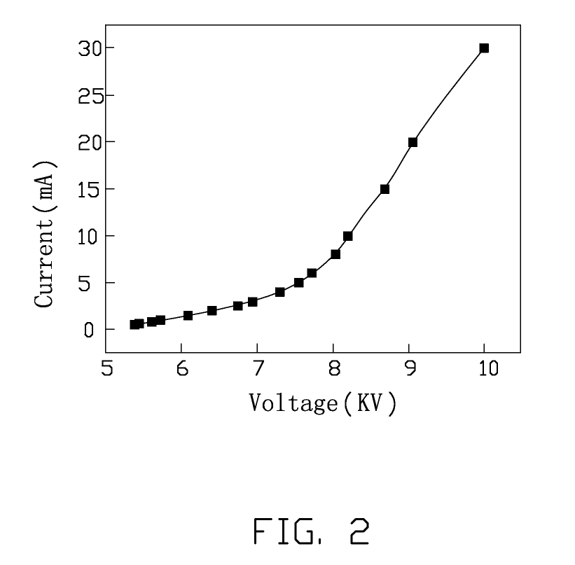

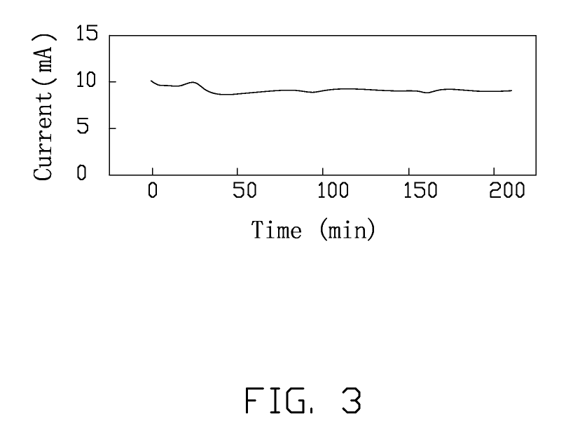

Referring to FIG. 2, a current-voltage curve and Fowler-Nordheim (F-N) curve for the field emission light source 100 is shown. It can be seen that, when the voltage is increased to about 8,000 volts (V), the emission current is significantly increased. Therefore, an ideal working voltage of the present field emission light source 100 is about 8000V. Referring to FIG. 3, a schematic test diagram of stability for the present field emission light source 100 is shown. The test diagram of stability is measured under a working voltage of 8021 volts (V). It can be seen that the present field emission light source can work long hours (i.e. 2-3 hours) at 8021 V while having a very high stability. At this working voltage, the present field emission light source 100 has a luminous efficiency of about 26.4 lumens per watt (lm/W). The theoretical working life of the field emission light source 100 is about 9000 hours.

A method for making the cathode 14 according to the present field emission light source 100 includes the following steps: (a) coating a slurry of silver onto the base 142, coating a slurry of carbon nanotubes onto the slurry of silver, and removing an organic carrier existing in the slurry of carbon nanotubes; (b) sintering the coated base 142 in a muffle furnace.

In step (a), the slurry of carbon nanotubes includes a plurality of carbon nanotubes, conductive metal particles, low-melting glass, and organic carriers. A concentration ratio of each element is as follows: about 5˜15% of the carbon nanotubes, about 10˜20% of the conductive metal particles, about 5% of the low-melting glass, and about 60˜80% of the organic carrier. The conductive metal particles are selected from tin indium oxide or silver. The organic carrier is a mixed carrier, which includes a large amount of terpineol mainly acting as solvent, a small amount of dibutyl phthalate acting as a plasticizer, and a small amount of ethyl cellulose acting as a stabilizer. The foregoing elements in a predetermined proportion are mixed, by the method of ultrasonic vibration, to form the slurry of carbon nanotubes stably and uniformly dispersed therein. The process of removing the organic carrier can be an oven-dried method, a natural weather method, or a hot-air dried method.

In step (b), a sintering temperature for the coated base 142 is about 425° C. Moreover, the sintering can be conducted in an atmosphere of nitrogen. In the process of sintering, the low-melting glass is melted, and thereby the carbon nanotubes can, opportunely, be bonded on the base 142 by the melted glass. Thereafter, the cathode emitter 144 is formed on the sintered base. The conductive metal particles can enable electrical connections to form between the carbon nanotubes and the base 142. The melting point of the low-melting glass is in the approximate range from 400° C. to 500° C. In order to further enhance field emission characteristics of the cathode 14, after drying and sintering, the surface of the cathode emitter 144 is gritted to make carbon nanotubes extend thereout in a consistent preferred orientation. As such, the cathode 14 with enhanced field emission characteristics is obtained. Furthermore, an adhesive tape can be used to bond on the surface of the cathode emitter 144 and enable the carbon nanotubes to extend thereout.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A field emission light source comprising:
a foundation;
a transparent shell disposed on the foundation, and thus defining a closed space therebetween;
a supporting member including a first end and a second end opposite to the first end,
the first end being connected to the foundation, and the second end being disposed at a center portion of the closed space;
an anode disposed on an inner surface of the transparent shell, and a fluorescent layer disposed on the anode;
a cathode comprising a plurality of carbon nanotubes disposed on the second end of the support member.

2. The field emission light source as claimed in claim 1, wherein the cathode comprises a polyhedron-shaped, spherical-shaped, or elliptical-shaped base, and the carbon nanotubes arranged on the base.

3. The field emission light source as claimed in claim 1, wherein the transparent shell is spherical-shaped, ellipsoidal-shaped, or pear-shaped.

4. The field emission light source as claimed in claim 3, wherein the base and the transparent shell are configured with a concentric center.

5. The field emission light source as claimed in claim 2, wherein a conductive adhesive layer is attached on a surface of the base.

6. The field emission light source as claimed in claim 5, wherein the carbon nanotubes are bonded on the conductive adhesive layer.

7. The field emission light source as claimed in claim 5, wherein the conductive adhesive layer is a slurry of silver.

8. The field emission light source as claimed in claim 1, wherein the anode is a transparent conductive film.

9. The field emission light source as claimed in claim 8, wherein the transparent conductive film is a tin indium oxide film.

10. The field emission light source as claimed in claim 8, wherein the anode is an aluminum film.

11. The field emission light source as claimed in claim 1, wherein a getter layer is configured within the transparent shell.

12. The field emission light source as claimed in claim 1, wherein the carbon nanotubes are selected from the group consisting of single-walled carbon nanotubes and multi-walled carbon nanotubes
